(19) United States
(12) Patent Application Publication
(10) Pub. No.: US 2025/0144927 A1
(43) Pub. Date: May 8, 2025

(54) METHOD AND APPARATUS FOR PATTERN METALLIZATION

(71) Applicant: Hazen Paper Company, Holyoke, MA (US)

(72) Inventors: John Hazen, South Hadley, MA (US); Don Harvourd, Ellington, CT (US)

(73) Assignee: Hazen Paper Company, Holyoke, MA (US)

(21) Appl. No.: 18/920,036

(22) Filed: Oct. 18, 2024

Related U.S. Application Data
(60) Provisional application No. 63/595,367, filed on Nov. 2, 2023.

(51) Int. Cl. B32B 38/10; B32B 37/00; B32B 37/12

(52) U.S. Cl. CPC B32B 38/10; B32B 37/025; B32B 37/1292

(57) ABSTRACT

A method for pattern metallization includes the steps of metallizing a first side of a film to form a metallized film, applying adhesive only to discrete areas of one of the metallized film and a substrate, and bonding said metallized film to the substrate.

### CROSS-REFERENCE TO RELATED APPLICATIONS

This application claims priority to U.S. Provisional Application No. 63/595,367, filed on Nov. 2, 2023, the entire disclosure of which is incorporated herein by reference.

### FIELD OF THE INVENTION

The present invention relates generally to a method and apparatus for transfer lamination and, more specifically, to a method and apparatus for pattern metallization using transfer lamination.

### BACKGROUND OF THE INVENTION

Transfer lamination is a process by which a layer of material is applied to a substrate. Generally, transfer lamination involves bonding a transfer film having an application layer, e.g., a metallized layer, to a paper or paperboard substrate, stripping the film from the substrate leaving the application layer on the substrate, and then optionally applying a coating to the application layer to facilitate printing. As will be appreciated, this process typically involves multiple, separate steps.

In particular, the transfer film is coated in an initial step with a breakaway layer that allows the film to be stripped from the substrate while leaving the application layer and the breakaway layer on the substrate. After the film is coated, the application layer is applied, e.g., the film is metallized. Once the film has been metallized, an adhesive is applied and the film is then bonded to the substrate via the adhesive, and the film/substrate is cured typically in an oven. Once removed from the oven, the film is stripped away from the substrate leaving the metallized layer on the substrate, and the substrate is coated (e.g., with a printable coating) and placed again in the oven to complete the process.

Existing methods of using transfer lamination to apply a metallized layer to a substrate, however, are limited in the designs and configurations that can be created, and can result in significant material waste. In view of the above, there is a need for a method and apparatus for pattern metallization whereby metallization can be applied to a substrate in any desired pattern, layout or configuration.

### SUMMARY OF THE INVENTION

It is an object of the present invention to provide a method and apparatus for pattern metallization.

It is another object of the present invention to provide a method and apparatus for pattern metallization using transfer lamination.

It is another object of the present invention to provide a method and apparatus for pattern metallization which provides a level of customization unavailable with known processes.

It is another object of the present invention to provide a method and apparatus for pattern metallization which provides an ease of manufacture and cost savings currently unavailable with known processes.

These and other objects are achieved by the present invention.

According to an embodiment of the present invention, a method for pattern metallization includes the steps of metallizing a first side of a film to form a metallized film, applying adhesive only to discrete areas of one of the metallized film and a substrate, and bonding said metallized film to the substrate.

According to another embodiment of the present invention, a system for pattern metallization of a substrate includes an applicator station for applying an adhesive to discrete areas of one of a metallized first side of a film and a substrate, a bonding station for bonding said metallized first side of said film to said substrate, and a stripping station for removing said film from said substrate to produce a substrate having metallization in areas corresponding to said discrete areas where said adhesive was applied to said metallized first side of said film and said substrate.

According to yet another embodiment of the present invention, a method for metallization includes the steps of metallizing a first side of a film to form a metallized film, with a gravure cylinder having one of a raised or embossed pattern, applying adhesive to one of said metallized film and said substrate in areas where said raised or embossed pattern contacts said metallized film or said substrate, and bonding said metallized first side of said film to said substrate.

### BRIEF DESCRIPTION OF THE DRAWINGS

FIG. 1 is a simplified schematic diagram of an apparatus for transfer lamination in accordance with an embodiment of the present invention.

FIG. 2 is a schematic illustration of a gravure cylinder of the apparatus of FIG. 1, according to one embodiment of the present invention.

FIG. 3 is a schematic illustration of a gravure cylinder of the apparatus of FIG. 1, according to another embodiment of the present invention.

### DETAILED DESCRIPTION OF THE PREFERRED EMBODIMENT

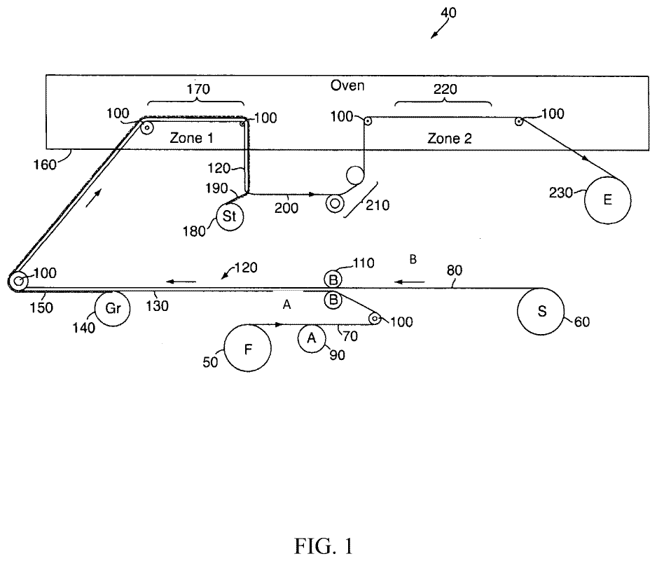

With reference to FIG. 1, a system/apparatus 40 for pattern metallization according to an embodiment of the present invention is shown. The inventive apparatus 40 provides the ability to apply a metallized layer to a substrate in a desired pattern or in distinct locations on the substrate. This is accomplished through the depicted apparatus 40 which includes a transfer film roll 50 and a substrate roll 60 which are unwound via motors in directions A and B respectively. The transfer film 70 is unwound from the transfer film roll 50 simultaneously with substrate 80 (which may be paper, board or any other material known in the art) as it is unwound from the substrate roll 60.

The transfer film 70 has been coated with a breakaway layer on a first side which is to be bonded to the substrate 80. The film 70 has also been previously metallized in a separate process known in the art. For the present discussion, the film is described as being new, i.e., no side has been previously coated with a breakaway layer. Alternatively, however, the breakaway later present on the first side could also be the result of having been previously used and inline coated as described in U.S. Pat. No. 9,938,111, which is hereby incorporated by reference herein in its entirety.

As the film 70 is unwound and travels in direction A, an adhesive/glue is applied atop the metallized layer by an applicator/gravure 90. The adhesive allows the film 70 and substrate 80 to be securely bonded. After the application of the adhesive, the film 70 encounters an idler roller 100, which changes the path of the film and guides it toward a bonding station.

In particular, the film 70 and substrate 80 are bonded through pressure bonding which is accomplished by rollers 110. Although rollers are depicted, it will be apparent that other means of bonding whether pressurized or not may be employed including the use of a pressurizing chamber instead of rollers.

Once the transfer film 70 has been bonded to the substrate 80, a first intermediate product 120 is formed. This intermediate product 120 includes the transfer film 70 with the substrate 80 bonded to the first side of the film 70. A second opposite side of the transfer film 130 remains uncoated.

Optionally, in an embodiment, this second, uncoated side 130 may then be passed through a gravure coating station 140. At the gravure station 140 a roller running in a coating bath (not shown) effectively deposits a coating onto the uncoated side 130 as it passes between the coating roller and a pressure roller (not shown). The gravure coating station 140 applies a breakaway layer 150 to the uncoated side 130 eliminating the need to coat the side 130 in a separate step prior to reuse in the present lamination process. By providing a breakaway layer 150 to the transfer film 70 during the lamination process, a normally separate manufacturing step is avoided facilitating the convenient, cost-effective reuse of the film 70.

While the present invention contemplates use of a gravure process, it will be appreciated that other coating methods for the inline application of the breakaway layer may be employed. Such methods may include reverse roll coating and the like as long as they can effectively apply the breakaway layer. Moreover, the gravure coating station 140 can be used to apply other types of coatings depending upon the desired end use of the film. That is, the inventive process can be used to create films for end uses other than reuse in a subsequent lamination process.

Returning now to FIG. 2, once past the gravure station 140, the now breakaway-coated intermediate product 120 encounters an idler roller 100, which directs the product 130 toward the oven 160. The intermediate product 130 enters a first zone 170 of the oven 160 where it is cured at a preselected temperature for a specific time period. The product 120 is then directed toward a stripping station 180 where the now pre-coated transfer film 190 is removed from the substrate leaving a substrate that includes the film's breakaway layer and metal layer bonded to its surface. This second intermediate product 200 is then directed toward a coating station 210 where it is coated with a printable coating to facilitate printing. Other coatings known in the art may also be utilized without departing from the broader aspects of the invention.

Once this coating has been applied, the second intermediate product 200 is directed toward the oven 160 where it is placed in a second zone to further cure. The result of this second curing process is the end product 230, which is collected on a roll 230. As will be appreciated this end product thus includes a substrate having a metal layer and a printable coating. The end product can then be sheeted or cut as desired depending on final intended application.

In sum, this transfer lamination process thus includes coating a first side of a transfer film with a breakaway layer, and then metallizing the first side of the transfer film. The metallized film is then bonded to the substrate via adhesive. Optionally, a breakaway coating can be applied to the reverse, second side of the transfer film while the film is bonded to the substrate (i.e., before stripping the film). The bonded film/substrate is then cured, such as in an oven. After curing, the transfer film is removed/stripped from the substrate. At this point, the substrate is coated with the breakaway layer and the metal layer. Optionally, a printable coating can then be applied atop the breakaway layer and metal layer.

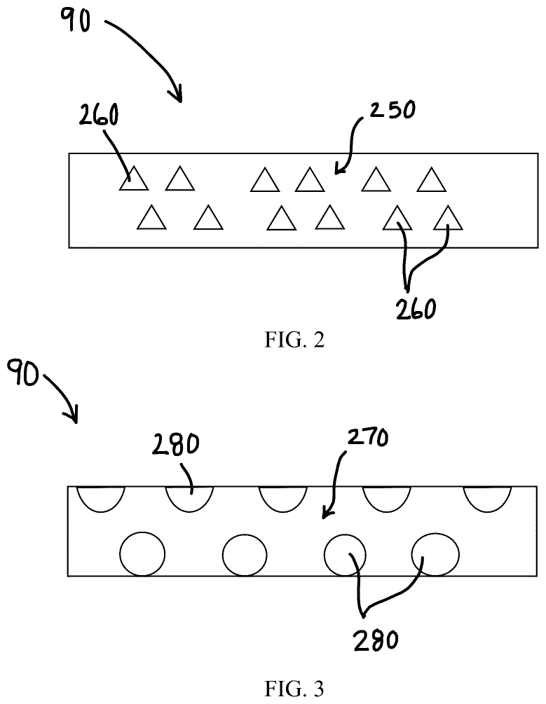

In an embodiment, instead of forming the end product having a metal layer over an entire surface of the substrate 80, the apparatus 40 can be configured so as to apply the metal layer in any desired pattern, configuration or layout on the substrate 80. For example, in an embodiment, as shown in FIGS. 2 and 3, the applicator 90, which applies the adhesive to the metallized transfer film, may be a gravure cylinder having an embossed or raised pattern. For example, as shown in FIG. 2, the gravure cylinder/applicator 90 may have a raised pattern 250 of repeating shapes such as triangles 260. Alternatively, as shown in FIG. 3, the gravure cylinder/applicator 90 may have a raised pattern 270 of repeating shapes such as circles 280. The present invention, however, is not intended to be so limited in this regard and, importantly, the gravure cylinder/applicator 90 may be configured with any pattern or configuration desired, for the purpose described hereinafter. In particular, the gravure cylinder/applicator 90 can have any shapes, elements, designs, patterns or discrete elements desired. That is, the configurations of gravure cylinder 90 shown in FIGS. 2 and 3 are exemplary only, but the designs on the cylinders are endless per application and customer request.

In use, the gravure cylinder 90 applies adhesive in a unique pattern to the metallized film 70. Upon nipping of the film 70 and substrate 80, the metalized layer of the transfer film 70 bonds to the substrate 80 only in the areas in which the adhesive is present. Upon stripping of the film at stripping station 180, what remains is an end product/substrate having metallization only in the areas in which the gravure cylinder 90 applied adhesive. In the areas where adhesive was not applied, the metallized layer remains affixed to the transfer film.

While the invention has been described above as applying adhesive to the metallized transfer film 70 using gravure cylinder 90 having a particular pattern or design, the present invention is not intended to be so limited in this regard. In particular, in an embodiment, instead of positioning gravure cylinder 90 to apply the adhesive to the metallized transfer film 70, the gravure cylinder 90 may be positioned so as to apply the adhesive to the substrate 80 in a desired pattern or design as it is unwound from roll 60. Upon nipping of the film 70 and substrate 80, the metalized layer of the transfer film 70 bonds to the substrate 80 only in the areas in which the adhesive is present on the substrate 80. Upon stripping of the film at stripping station 180, what remains, as described above, is an end product/substrate having metallization only in the areas in which the gravure cylinder 90 printed adhesive. Moreover, it is contemplated that the adhesive can be applied to the metallized film or substrate using any device or process known in the art, and is not intended to be limited to gravure cylinder application.

The present invention thus provides a system and method for application of transfer metallization in a pattern metallization format.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A method for pattern metallization, said method comprising the steps of:
metallizing a first side of a film to form a metallized film;
applying adhesive only to discrete areas of one of the metallized film and a substrate; and
bonding said metallized film to the substrate.

2. The method according to claim 1, wherein:
the discrete areas form a repeating pattern.

3. The method according to claim 1, wherein:
the discrete areas are in the form a non-repeating pattern.

4. The method according to claim 1 wherein:
the discrete areas form a custom design.

5. The method according to claim 1, wherein:
the adhesive is applied to the metallized film.

6. The method according to claim 1, wherein:
the adhesive is applied to the substrate.

7. The method according to claim 1, wherein:
the adhesive is applied using a gravure cylinder having one of a raised or embossed pattern.

8. The method according to claim 1, further comprising the step of:
curing said bonded metallized film and substrate in a first oven.

9. The method according to claim 8, further comprising the step of:
removing said film from said substrate leaving metal from said film deposited on said substrate in only discrete areas of said substrate corresponding to the discrete areas of the metallized film where the adhesive was applied.

10. The method according to claim 1, further comprising the steps of:
applying a first coating to a second side of said film at a first gravure station after it has been bonded to said substrate;
curing said bonded film and substrate in a first oven; and
removing said film from said substrate leaving metal from said film deposited on said substrate thereby producing a metalized substrate, and a film having the first coating on the second side of the film.

11. The method according to claim 10, wherein:
the first coating is a breakaway coating.

12. The method according to claim 1, further comprising the step of:
removing said film from said substrate leaving metal from said film deposited on said substrate in only discrete areas of said substrate corresponding to the discrete areas of the metallized film where the adhesive was applied.

13. A system for pattern metallization of a substrate, said system comprising:
an applicator station for applying an adhesive to discrete areas of one of a metallized first side of a film and a substrate;
a bonding station for bonding said metallized first side of said film to said substrate; and
a stripping station for removing said film from said substrate to produce a substrate having metallization in areas corresponding to said discrete areas where said adhesive was applied to said metallized first side of said film and said substrate.

14. The system of claim 13, wherein:
said bonding station is configured to bond said metallized first side of said film to said substrate only at said discrete areas where said adhesive is applied.

15. The system of claim 13, further comprising:
a first curing station for curing said bonded film and substrate.

16. The system of claim 13, further comprising:
a first coating station for applying a first coating to an exposed, second side of said film after said metallized first side of said film is bonded to said substrate and while it is bonded to said substrate, said substrate imparting rigidity to said film while said first coating is applied.

17. The system of claim 13, wherein:
said applicator station includes a gravure cylinder having one of a raised or embossed pattern.

18. The system of claim 17, wherein:
the pattern is a repeating pattern.

19. A method for metallization, said method comprising the steps of:
metallizing a first side of a film to form a metallized film;
with a gravure cylinder having one of a raised or embossed pattern, applying adhesive to one of said metallized film and said substrate in areas where said raised or embossed pattern contacts said metallized film or said substrate; and
bonding said metallized first side of said film to said substrate.

20. The method according to claim 19, further comprising the step of:
removing said film from said substrate leaving metal from said film deposited on said substrate only in said areas where said metallized first side of said film was bonded to said substrate.
